(19) United States
(12) Patent Application Publication
(10) Pub. No.: US 2025/0145337 A1
(43) Pub. Date: May 8, 2025

(54) RECYCLABLE PACKAGING AND MANUFACTURING METHOD

(71) Applicant: AISAPACK HOLDING SA, Vouvry (CH)

(72) Inventors: Gilles DEMAUREX, Martigny (CH); Jacques THOMASSET, Neuvecelle (FR)

(21) Appl. No.: 18/835,317

(22) PCT Filed: Feb. 16, 2023
(86) PCT No.: PCT/IB2023/051408

§ 371 Date: Aug. 1, 2024

(30) Foreign Application Priority Data
Mar. 17, 2022 (EP) 22162602.1

(51) Int. Cl. B65D 35/10; B65D 1/02; B65D 65/46

(52) U.S. Cl. CPC B65D 35/10; B65D 1/0215; B65D 65/466

(57) ABSTRACT

The present invention relates to recyclable packaging comprising parts (1,9,10,11,12) assembled to one another, at least one of said parts of the packaging comprising a structural layer (2) made of a first type of material and a functional layer (3) made of a second type of material, said layers (2,3) being attached to one another by a peelable interface (7) which makes it possible to ensure sufficient adhesion between said structural and functional layers (2,3) to maintain the integrity of the packaging during its use and to separate said layers so that they can be recycled in their respective appropriate recycling channel after they have been separated. The present invention also relates to a method for recycling such packaging.

### CORRESPONDING APPLICATIONS

The present application claims the priority of the earlier European application No EP22162602.1 filed on 17 Mar. 2022 in the name of AISAPACK HOLDING SA, the contents of this earlier application being incorporated in full by reference in the present application.

### TECHNICAL FIELD

The invention relates to the field of packaging based on cellulose or made of recyclable plastic. It concerns more specifically packaging having a reduced environmental impact. The invention applies to the field of packaging comprising a cylindrical body made from a sheet. The invention applies in particular to recyclable flexible tubes for containing products such as creams or pastes, or bottles for cosmetic products, or cartridges for containing products such as glue or mastic, or cylindrical packaging (cans, flexible pouches) for containing liquid or dry products.

### PRIOR ART

These types of packaging are known for example from the following publications: WO 2022/229810, EP1260447, FR2505250, GB1118632, U.S. Pat. Nos. 2,119,926 and 4,132,331.

### SUMMARY AND PRINCIPLE OF THE INVENTION

The invention relates to packaging such as tubes or bottles comprising at least a tubular body made from a sheet for example based on cellulose. The wall of the tubular body comprises at least a first structural layer based on cellulose and a second layer, referred to as a functional layer, forming the inner layer of the packaging. According to the invention, the adhesion between the two layers is adjusted in order to allow easy separation of the structural and functional layers when the packaging has reached the end of its life. A preferred embodiment of the invention consists in adding internal and external reinforcing strips at the weld. According to this embodiment, the external strip is used at the end of life to facilitate separation of the layers and the internal strip is used to keep the packaging sealed after having separated the structural layer based on cellulose. The invention makes it possible to facilitate recycling of the packaging, the structural layer, which forms the majority of the packaging, for example based on cellulose comprising a minimum of 85% cellulose, being recycled with paper, while the functional layer of the packaging, for example based on polyethylene (PE) or polypropylene (PP), is recycled in the appropriate recycling channel. The first part of the invention is advantageously used to reduce the environmental impact of tubes or bottles or cartridges of mastic.

The principle of this invention is therefore to use at least two types of material to respectively form the structural layer and the functional layer, which are recycled in different channels, to assemble them with a “peelable” interface so as, first of all, to ensure said materials are assembled with sufficient adhesion for the use of the packaging and, second, to allow said materials to be separated at the end of the life of the packaging for the purposes of recycling said materials in their appropriate recycling channels.

In some embodiments, the invention relates to recyclable packaging comprising parts assembled to one another so as to form the packaging, at least one of said parts of the packaging comprising a structural layer made of a first type of material and a functional layer made of a second type of material, said types of material having different recycling channels, said structural and functional layers being attached to one another by a peelable interface which ensures sufficient adhesion between said structural and functional layers to maintain the integrity of the packaging at least during its use and the separation of the layers allowing the structural and functional layers to be recycled in their appropriate recycling channels after they have been separated.

In some embodiments, the parts of the packaging comprise a body, for example tubular, and additional parts. These additional parts may be a head and/or a base and/or a cap.

In some embodiments, the structural layer may be based on cellulose and the functional layer may be based on synthetic material(s). Other materials are possible for forming the structural layer and the functional layer: for example, metals (such as aluminium, bio-based polymers, compostable polymers, etc.). The structural and functional layers may be monolayer or multilayer.

This principle of the invention applies not only to the body of the packaging but may also apply to other parts/portions of the packaging (described for example as “additional parts” in the present application), such as the head of a tube, the cap, or the base of the packaging. Thus, each of the given parts of the packaging may comprise at least one such structural layer and one such functional layer attached to one another by a peelable interface, and the principle of the present invention applies to these parts in order to allow recycling in the appropriate recycling channels according to the principles of the present invention.

In some embodiments of the invention, the separation is started during the use of the packaging or after the use of the packaging.

In some embodiments of the invention, at least a part of the packaging comprises an external strip secured or connected to the structural layer by a peelable interface in such a way that the external strip may be used to facilitate the separation between the structural layer and the functional layer.

In some embodiments of the invention, the external strip may be at least partially separated from the structural layer at the end of the life of the packaging, for example upon separation of the structural and functional layers.

In some embodiments of the invention, the external strip is made of the first type of material. In some embodiments, the first type of material is based on cellulose.

In some embodiments of the invention, at least a part of the packaging comprises an internal strip secured to the functional layer, said internal strip making it possible to keep the packaging sealed after separation of the structural and functional layers.

In some embodiments of the invention, the internal strip is made of the second type of material.

Depending on the part of the packaging in question (body, tube head, cap, base), such a strip may or may not be used. The internal and external strips may be monolayer or multilayer.

In some embodiments of the invention, the functional layer is based on polyethylene, preferably based on high density polyethylene, and/or based on polypropylene and/or based on bio-based and/or biodegradable resin.

In some embodiments of the invention, the packaging forms, after separation, two recyclable pieces of waste comprising a first piece of waste comprising one or more structural layer(s) (originating from the body and/or from the additional parts of the packaging) and a second piece of waste comprising at least one or more functional layers(s) (originating from the body and/or from the additional parts of the packaging).

In some embodiments of the invention, the first piece of waste may comprise the external strip and the second piece of waste may comprise the internal strip.

In some embodiments of the invention, the second piece of waste comprises a resin representing at least 80% of the plastic piece of waste.

In some embodiments of the invention, the tubular body and/or the additional parts respectively comprise a structural layer based on cellulose and a functional layer based on plastic, in such a way that the first piece of waste comprises the structural layer of the body and/or the additional parts and the second piece of waste comprises the functional layer of the body and/or the additional parts.

In some embodiments of the invention, the structural layer is monolayer or multilayer and the functional layer is monolayer or multilayer.

In some embodiments of the invention, the packaging forms a tube and the additional parts are a tube head and a cap.

In some embodiments of the invention, the packaging forms a bottle and the additional parts are a tube head, a cap and a base.

In some embodiments of the invention, the packaging forms a cartridge and the additional parts are a tube head, a cap and a base.

In some embodiments, the invention relates to a method for recycling packaging comprising parts assembled to one another so as to form said packaging, at least one of said parts of the packaging comprising a structural layer made of a first type of material and a functional layer made of a second type of material, said layers being attached to one another by a peelable interface which ensures adhesion between said layers making it possible to maintain the integrity of the packaging during use thereof, in which method the layers are separated at their peelable interface in such a way that they can be recycled in their appropriate recycling channels after they have been separated.

In some embodiments of the invention, separation of the layers is started during the use or after the use of the packaging.

In some embodiments of the method according to the invention, the packaging comprises at least an external strip secured or connected to a structural layer by a peelable interface, and the external strip is used to facilitate the separation between the structural layer and the functional layer at the peelable interface.

In some embodiments of the method according to the invention, at least the packaging comprises an internal strip secured or connected to a functional layer in such a way that sealing of the packaging can be maintained after separation of the structural and functional layers.

In some embodiments of the method according to the invention, the external strip is least partially separated from the structural layer.

In some embodiments of the method according to the invention, two pieces of waste are formed from the packaging by separation, said pieces of waste being formed at least of the layers of the parts of the packaging.

### BRIEF DESCRIPTION OF THE DRAWINGS

FIGS. 1 to 9 illustrate the invention relating to a piece of recyclable packaging, the structural layer (for example based on cellulose) of which is separated from the rest of the packaging at the end of life.

FIG. 1 shows a preferred embodiment of the weld.

FIG. 2 illustrates the principle of separation of the structural and functional layers.

FIG. 3 shows a view in section through the tubular body before separation of the structural and functional layers.

FIG. 4 shows a view in section through the tubular body after separation of the structural and functional layers.

FIG. 5 shows the invention applied to a tube based on cellulose.

FIG. 6 shows the invention applied to a bottle based on cellulose.

FIG. 7 shows a view in section through a cartridge.

FIG. 8 shows the separation of the structural and functional layers as the cartridge of FIG. 7 is emptied.

FIG. 9 shows the layer of cellulose separated from the rest of the packaging.

FIG. 10 illustrates the principle of the invention applied to different parts of a packaging.

### DETAILED DESCRIPTION

1: packaging part or portion
2: structural layer
3: functional layer
4: external strip
5: internal strip
6: edge of the sheet
7: peelable interface
8: edge to edge assembly
9: tubular body
10: head
11: cap
12: base
13: tube
14: bottle
15: piece of waste for example based on cellulose
16: piece of waste for example based on resin
17: cartridge
20: structural layer, for example based on cellulose, of the head
21: structural layer, for example based on cellulose, of the cap
22: structural layer, for example based on cellulose, of the base
30: functional layer of the head
31: functional layer of the cap
32: functional layer of the base

The invention relates to recyclable packaging comprising at least a tubular body comprising a structural layer and a functional layer characterized in particular in that the two layers can be separated and recycled in their appropriate recycling channels.

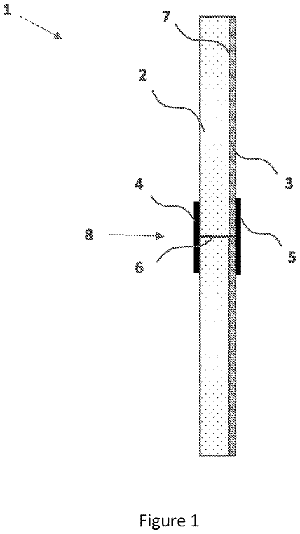

FIG. 1 shows a view in section through a part of a tubular body which is obtained by welding a sheet, according to embodiments of the invention. The view in section through the packaging part 1 shows the assembly of the sheet comprising at least a structural layer 2, for example based on cellulose, and a functional layer 3, for example based on resin. According to the invention, the structural layer 2 is connected to the functional layer 3 by a peelable interface 7 which allows the layers to be separated at the end of the life of the packaging. In other words, the adhesive force between the layers 2 and 3 is adjusted by means of the interface 7 to ensure the integrity of the packaging during use thereof and to allow the layers 2, 3 to be separated at the end of the life of the packaging: therefore, each layer 2, 3 can be recycled in its own appropriate recycling channel.

According to embodiments of the invention, the functional layer 3 provides the properties necessary to preserve the packaged product (for example barriers against moisture and gases, or food grade or weldability properties). The functional layer 3 has a small thickness, preferably less than 50 microns. It may have a monolayer or multilayer structure, with a preferred embodiment in which one of the resins of the layer 3 represents at least 80% of said layer. In this preferred embodiment, use is made, for example, of SiOx or metallized layers to provide gas barrier properties, recyclable plastics, bio-based or compostable polymers, etc.

According to embodiments of the invention, the structural layer 2 provides the rigidity and the stability of the packaging; it allows the packaging to be handled and stored easily by the user. The structural layer 2 also serves as a communication medium and is preferably printed over the whole or a portion of its surface. The functional layer 2 may be based on cellulose and comprise at least 80% cellulose and preferably at least 90% cellulose so that it can be recycled in the paper recycling channel. Metals, bio-based or compostable polymers, etc. are also possible.

According to embodiments of the invention, the tubular part of the packaging is produced from a sheet which is welded or adhesively bonded by means of an external strip 4 and an internal strip 5, said strips being secured to the structural layer 2 and the functional layer 3, respectively. The strips 4 and 5 reinforce the weld and guarantee the integrity of the packaging during use. According to a preferred embodiment of the assembly shown in FIG. 1, the edges 6 of the sheet are juxtaposed end to end in the zone of welding. According to an alternative embodiment not shown, the edges are superposed in the zone of welding.

According to embodiments of the invention, the external strip 4 is used to facilitate the separation between the structural layer 2 and the functional layer 3 when the packaging is recycled. Thus, the external strip 4 has special packaging separation means, for example a peelable interface with the layer 2.

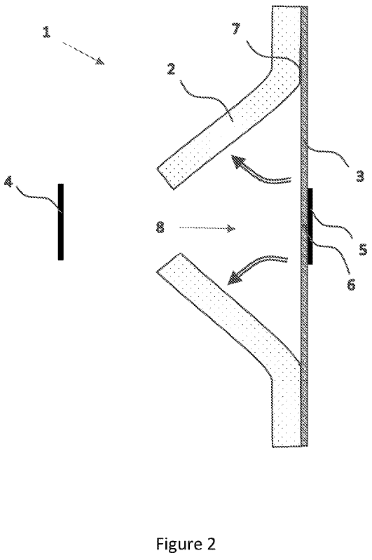

FIG. 2 shows an embodiment of the mechanism for separation of the layers 2, 3 with a view to recycling of the packaging. The external strip 4 is separated at least partially from the packaging, thus giving access to the ends of the structural layer 2 which in turn may be separated from the packaging by virtue of the peelable interface 7 between the structural layer 2 and the functional layer 3. One advantage of the embodiment shown in FIG. 2 is linked to the fact that sealing of the packaging is preserved thanks to the internal strip 5 connecting the ends 6 of the layer 3. Therefore, in spite of the separation of the structural layer 2, the remainder of the packaged product is still enclosed inside the packaging, which is a major advantage in terms of hygiene from the user point of view.

According to a preferred embodiment of the invention, the external strip 4 is based on cellulose and remains connected at least partially to the layer 2 when the separation takes place. This preferred embodiment makes it possible to recycle the external strip 4 at the same time as the layer 2 and in the same recycling channel if they are made of identical materials or materials of the same nature.

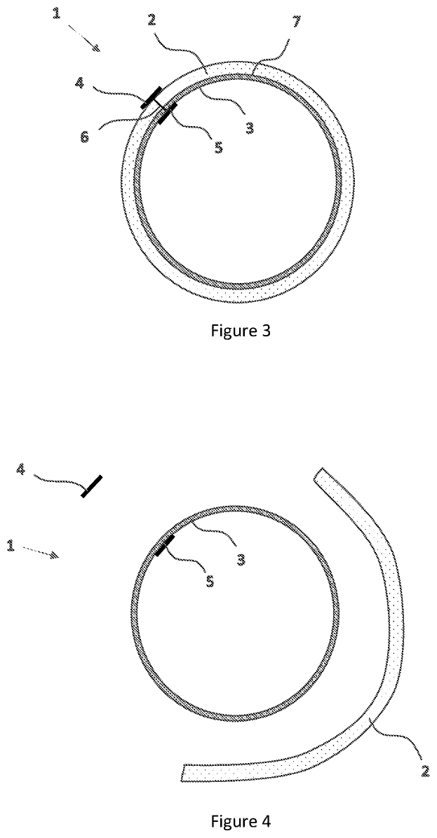

FIG. 3 shows a view in section through an embodiment of a tubular body of packaging according to the invention. The external strip 4 is used to facilitate separation of the layers 2 and 3 at the time of recycling, while the internal strip 5 makes it possible to keep the packaging sealed even after separation of the layers.

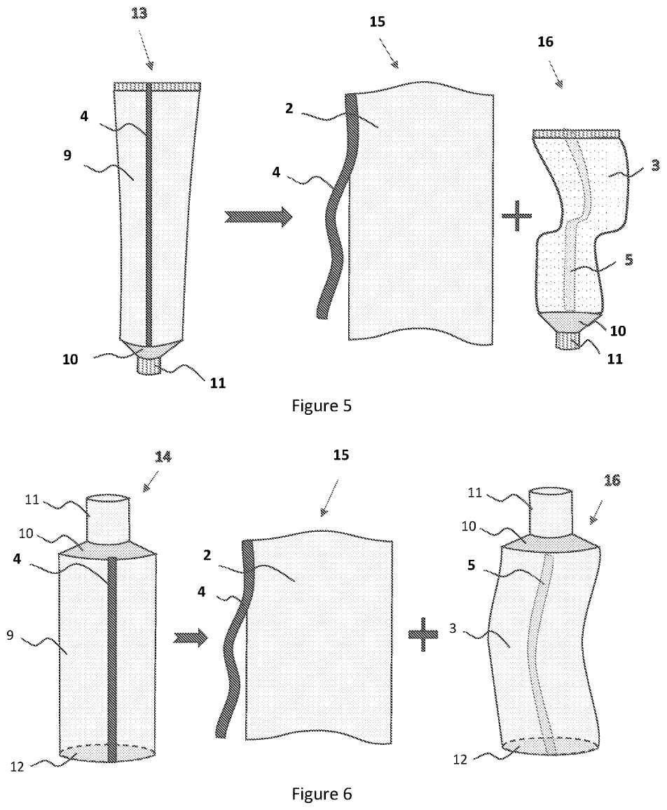

FIG. 4 shows an embodiment of a mechanism for separation of the layer 2 from the rest of the packaging. Preferably, the external strip 4 used to start the separation of the layers remains partially attached to the layer 2, this being shown in FIGS. 5, 6 (see the drawing in the middle) and 9 (see the drawing on the left-hand side).

FIG. 5 shows an embodiment with a tube 13 intended to contain viscous or pasty products, produced according to the invention. The tube 13 shown in FIG. 5 comprises as parts a tubular body, connected to a tube head 10 and a cap 11. The tube 13, in terms of appearance and usage properties, is similar to known commercially available tubes. In particular, the tube 13 has the same advantages and user-friendliness properties as this type of packaging, such dispensing properties, preservation properties, ease of use and an advantageous ratio between the quantity of product packaged and the weight of the packaging. FIG. 5 also shows the separation of the packaging into two recyclable pieces of waste: a first piece of waste 15 based on cellulose comprising the structural layer 2 and the external strip 4, and a second piece of waste 16, which is very lightweight, based on a recyclable resin. According to embodiments of the invention, the piece of waste 16 based on resin comprises a resin representing at least 80% of the plastic piece of waste and preferably at least 90%. According to embodiments of the invention, the piece of waste 16 comprises at least the functional layer 3, the internal strip 5, the tube head 10 and the cap 11. According to a first embodiment, the piece of waste 16 is based on polyethylene and preferably based on high density polyethylene. According to a second embodiment, the piece of waste 16 is based on polypropylene. According to a third embodiment, the piece of waste 16 is based on bio-based and/or biodegradable resin. Other equivalent materials are of course possible depending on the product present in the packaging.

According to another embodiment of the tube 13 according to the invention, the tubular body 9 and/or the tube head 10 and/or the cap 11 respectively comprise a structural layer 2 based on cellulose and a functional layer 3 based on plastic. At the end of the life of the packaging, the respective structural layers 2 based on cellulose of the tubular body 9 and/or the tube head 10 and/or the cap 11 are separated and recycled in the paper recycling channel. The remaining functional layers 3 of the tubular body 9, the tube head 10 and the cap 11 are recycled in the plastics recycling channel. According to this principle, all the parts of the packaging, or at least the majority of the parts of the packaging, are formed of such structural 2 and functional 3 layers which may, at the end of the life of the packaging, be recycled in the appropriate recycling channels.

FIG. 6 shows an embodiment of a bottle 14 produced according to the invention. The bottle 14 comprises a tubular body 9 connected to a base 12 and to a head 10 having a neck and closed by a cap 11. FIG. 6 also shows the separation of the layer 2, for example based on cellulose, from the rest of the bottle upon recycling. The removal of the external strip 4 at least partially from the bottle 9 facilitates the separation of the layer 2. As shown in FIG. 6, the bottle 14 results in two recyclable pieces of waste: a first piece of waste 15, for example based on cellulose, comprising the layer 2 in the form of a sheet and the external strip 4, and a second piece of waste 16, for example based on plastic resin, comprising the base 12, the functional layer 3, the internal strip 5, the head 10 and the cap 11. The first piece of waste 15 is recycled in the paper recycling channel and the second piece of waste 16 is recycled in the plastics recycling channel.

According to another embodiment of a bottle 14 according to the invention, the tubular body 9 and/or the base 12 and/or the head 10 and/or the cap 11 respectively comprise a structural layer 2, for example based on cellulose, and a functional layer 3, for example based on plastic. At the end of the life of the bottle 14, the respective structural layers 2 based on cellulose of the tubular body 9 and/or the base 12 and/or the tube head 10 and/or the cap 11 are separated and recycled in the paper recycling channel. The functional layers 3 based on plastic of the tubular body 9, the base 12, the tube head 10 and the cap 11 are recycled in the plastics recycling channel.

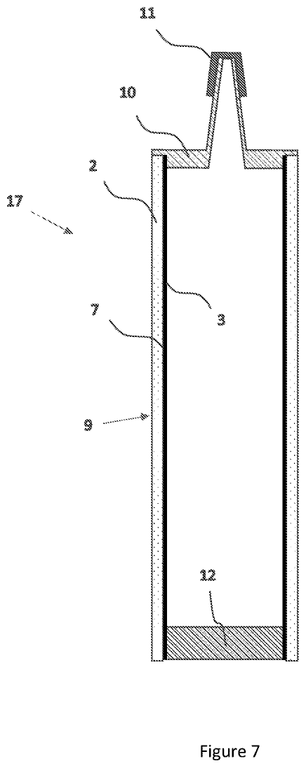

FIG. 7 shows a cartridge 17 for dispensing viscous products such as mastic or adhesive. The cartridge 17 comprises a tubular body 9 connected to a base 12 and to a head 10 having a neck and closed by a cap 11. The tubular body 9 comprises at least a structural layer 2, for example based on cellulose, and a functional layer 3, for example based on plastic resin. The base 12 is secured to the functional layer 3 of the tubular body. The cartridge shown in FIG. 7 is used with a tool called a “gun” (not shown) which makes it possible to extract the product from the cartridge 17 by virtue of an axial force applied to the base 12, which moves in the tubular body 9.

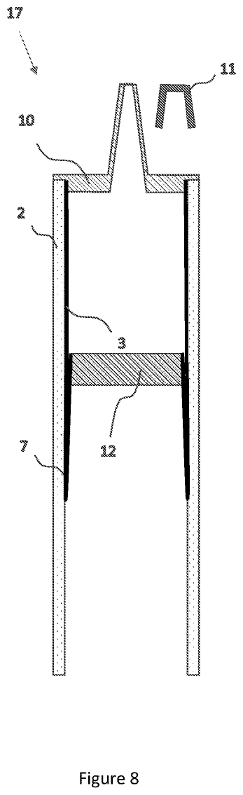

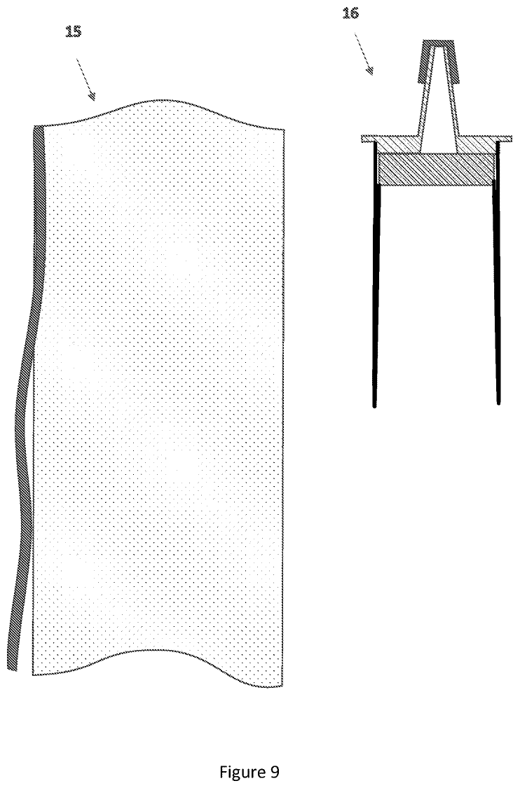

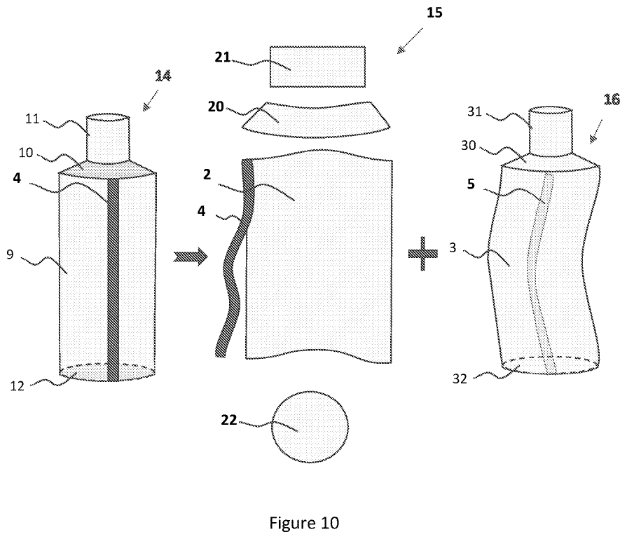

FIG. 8 shows the configuration of the cartridge 17 during use and, specifically, when some of the product has already been extracted from the cartridge 17. As the cartridge 17 is emptied, the base 12 slides inside the tubular body 9 by virtue of the pressure exerted on the base by the gun. According to the invention, the movement of the base 12, which is secured to the functional layer 3, causes the functional layer 3 and the structural layer 2 to separate at the interface 7 during use of the packaging 17 while preserving the integrity of the packaging 17. According to the invention, the adhesive force at the interface 7 is adjusted to ensure the separation of the layers 2, 3. The separation of the packaging 17 into two pieces of waste 15, 16 occurs (or may occur) when the base 12 reaches the head 10 as a result of its sliding movement and when the cartridge 17 is empty (see FIG. 9, drawing on the right-hand side).

FIG. 9 shows the separation of the cartridge 17 into two pieces of waste: a first piece of waste 15, for example based on cellulose, comprising the layer 2 and the external strip 4, and a second piece of waste 16, for example based on plastic, comprising the base 12, the functional layer 3, the internal strip 5, the head 10 and the cap 11.

According to another embodiment of the cartridge 17 according to the invention, the tubular body 9 and/or the base 12 and/or the head 10 and/or the cap 11 respectively comprise a structural layer 2, for example based on cellulose, and a functional layer 3, for example based on plastic. At the end of the life of the cartridge 17, the respective structural layers 2 based on cellulose of the tubular body 9 and/or the base 12 and/or the tube head 10 and/or the cap 11 are separated and recycled in the paper recycling channel. The functional layers 3 based on plastic of the tubular body 9, the base 12, the tube head 10 and the cap 11 are recycled in the plastics recycling channel.

Embodiments have been described to facilitate a general understanding of the principles of the structure, the operation, the manufacturing and the use of the systems and methods described in the present application. One or more of these embodiments are shown in the appended drawings. The systems and methods specifically described in the present application and shown in the appended drawings are non-limiting embodiments and the scope of the present invention is not defined only by the claims. The features illustrated or described in relation to one embodiment may be combined with the features of other embodiments. Such modifications and variants are intended to be included in the scope of the present invention. A given number of problems encountered with conventional methods and systems are mentioned herein and the methods and systems described herein may solve one or more of these problems. Furthermore, while this invention has been described together with a given number of embodiments, the alternatives, modifications, equivalents and variants which fall within the spirit and the scope of the present invention are also covered by the present application.

1.-22. (canceled)

23. Recyclable packaging (13,14,17) comprising parts (1,9,10,11,12) assembled to one another so as to form said packaging, at least one of said parts of the packaging comprising a structural layer (2) made of a first type of material and a functional layer (3) made of a second type of material, said structural and functional layers (2,3) being attached to one another by a peelable interface (7), said interface (7) making it possible to ensure sufficient adhesion between said structural and functional layers (2,3) to maintain the integrity of the packaging during its use and to separate said structural and functional layers (2,3) so that they can be recycled in their appropriate recycling channels after they have been separated wherein at least a part of the packaging comprises an external strip (4) secured to the structural layer (2) by a peelable interface in such a way that the external strip (4) is used to facilitate the separation between the structural layer (2) and the functional layer (3) of said part.

24. Packaging according to claim 23, wherein said parts of the packaging comprise a tubular body (9) and/or additional parts (10,11,12).

25. Packaging according to claim 23, wherein said additional parts comprise a head and/or a base and/or a cap.

26. Packaging according to claim 25, wherein the external strip (4) is at least partially separated from the structural layer (2) upon separation of the structural layer (2) and the functional layer (3).

27. Packaging according to claim 23, wherein the external strip (4) is made of the first type of material.

28. Packaging according to claim 23, wherein the first type of material is based on cellulose.

29. Packaging according to claim 23, wherein at least a part of the packaging comprises an internal strip (5) secured to the functional layer (3), said internal strip (5) making it possible to keep the packaging sealed after separation of the structural (2) and functional (3) layers.

30. Packaging according to claim 29, wherein the internal strip (5) is made of the second type of material.

31. Packaging according to claim 23, wherein the second type of material is based on polyethylene, and/or based on polypropylene and/or based on bio-based and/or biodegradable resin.

32. Packaging according to claim 23, said packaging forming, after separation, two recyclable pieces of waste comprising a first piece of waste (15) comprising at least one structural layer (2) and a second piece of waste (16) comprising at least one functional layer (3).

33. Packaging according to claim 32, wherein the first piece of waste comprises the external strip (4) and/or the second piece of waste (16) comprises the internal strip (5).

34. Packaging according to claim 23, wherein the structural layer (2) is monolayer or multilayer and the functional layer (3) is monolayer or multilayer.

35. Packaging according to claim 23, wherein the packaging forms a tube (13) and the additional parts are a tube head (10) and a cap (11).

36. Packaging according to claim 23, wherein the packaging forms a bottle (14) and the additional parts are a tube head (10), a cap (11) and a base (12).

37. Packaging according to claim 23, wherein the packaging forms a cartridge (17) and the additional parts are a tube head (10), a cap (11) and a base (12).

38. Method for recycling packaging comprising parts assembled to one another so as to form said packaging, at least one of said parts of the packaging comprising a structural layer made of a first type of material and a functional layer made of a second type of material, said functional and structural layers being attached to one another by a peelable interface, said interface making it possible to ensure sufficient adhesion between said functional and structural layers to maintain the integrity of the packaging during use thereof, in which method the structural and functional layers are separated at their peelable interface in such a way that they can be recycled in their appropriate recycling channel after they have been separated.

39. Method according to claim 38, wherein separation of the layers is started during the use or after the use of the packaging.

40. Method according to claim 38, wherein the packaging comprises an external strip secured to a structural layer by a peelable interface, and the external strip is used to facilitate the separation between the structural layer and the functional layer at the peelable interface.

41. Method according to one of claim 38, wherein the packaging comprises an internal strip secured to the functional layer in such a way that sealing of the packaging is maintained after separation of the structural and functional layers.

42. Method according to one of claim 38, wherein the external strip is least partially separated from the structural layer.

43. Method according to one of claim 38, wherein at least two recyclable pieces of waste are formed from the packaging by separation.
